(19) United States
(12) Patent Application Publication
(10) Pub. No.: US 2026/0004339 A1
(43) Pub. Date: Jan. 1, 2026

(54) DYNAMIC FLOOR VALUE OPTIMIZATION USING MACHINE LEARNING MODELS

(71) Applicant: Quizlet, Inc., San Francisco, CA (US)

(72) Inventor: Lauren McCombs, Santa Ana, CA (US)

(21) Appl. No.: 19/254,471

(22) Filed: Jun. 30, 2025

Related U.S. Application Data
(60) Provisional application No. 63/665,807, filed on Jun. 28, 2024.

(51) Int. Cl. G06Q 30/08; G06N 20/20

(52) U.S. Cl. CPC G06Q 30/08; G06N 20/20

(57) ABSTRACT

A computer-implemented method comprising collecting bid data corresponding to bids of different user computers in a real-time computer-implemented auction, wherein each user computer is associated with a digital content item that a content server can serve to a web server; based on bid data parameters of the bid data, aggregating digital identifiers of user computers into a plurality of user groups, and digitally storing a training dataset comprising the bid data parameters and the user groups; training a machine learning model (MLM) using the training dataset to create and store a trained MLM; executing an inference stage of the trained MLM over input data comprising characteristics of a particular user group from among the plurality of user groups and revenue-per-thousand impressions data (RPM data) to output a prediction of a group-associated floor bid value for the particular user group; transmitting, to the content server, the floor bid value and an identifier of the particular user group; and dynamically adjusting, by the content server, a frequency of updating the floor bid value, wherein the adjusting occurs when an average maximum bid price for a set of auctions exceeds the floor bid value.

### CROSS-REFERENCE TO RELATED APPLICATIONS

This application claims the benefit under 35 U.S.C. 119 of provisional application 63/665,807, filed Jun. 28, 2024, the entire contents of which are hereby incorporated by reference for all purposes as if fully set forth herein.

### TECHNICAL FIELD

The present disclosure generally relates to computer-implemented dynamic optimization of floor values using machine learning models.

### BACKGROUND

Distributed computer systems under stored program control are used to execute transaction processing with the delivery of content items and the mediation of auctions in many industrial domains. In some cases, the floor value associated with a particular auction can significantly impact the efficiency of auction processing. A floor value can be the minimum permitted value of a data item, such as a bid, associated with an auction. Client-server computer systems can enforce a floor value using server-side software programmed to automatically reject or decline transaction requests or bids of clients having values below the floor value.

One domain in which these techniques can be applied is computer-implemented content delivery, including but not limited to the delivery of digital ads. Digital advertising has revolutionized modern marketing, allowing businesses to reach diverse audiences through online platforms like display, video, and social media ads. Distributed computer systems control the transmission of content items like digital ads using real-time bidding (RTB), where deliveries of digital content items (such as ad impressions) are bought and sold in automated auctions. Advertisers use demand-side platforms (DSPs) to bid on ad space in websites, videos, or social media feeds, while publishers use supply-side platforms (SSPs) to sell them. Computer-implemented ad exchanges facilitate these transactions, ensuring the highest bidder's ad is shown to the user. Setting appropriate floor bid values representing the minimum price for an ad impression is important for maintaining ad quality and the proper operation of an effective system.

### SUMMARY

The appended claims may serve as a summary of the invention.

### BRIEF DESCRIPTION OF THE DRAWINGS

In the drawings:

FIG. 1 illustrates a distributed computer system for real-time bidding for the electronic delivery of digital content items, according to one embodiment.

FIG. 2 illustrates a computer-implemented method of determining a floor bid value using a machine-learning model in one embodiment.

FIG. 3 illustrates a computer-implemented method of training a machine learning model for determining a floor bid value in one embodiment.

FIG. 4 is a computer system with which one embodiment could be implemented.

### DETAILED DESCRIPTION

The present disclosure describes systems and methods leveraging advanced machine learning techniques to optimize floor values precisely by analyzing diverse data points. One practical application of the technology is ensuring effective ad placements.

The present disclosure addresses technological challenges in setting and adjusting floor bid values during real-time, computer-implemented bidding in online or software-mediated auctions. Certain methods in the relevant technical field often fail to adapt to real-time conditions, leading to inefficiencies and suboptimal outcomes. By training machine learning models and evaluating the trained ML models in the inference stage, such as an Extreme Gradient Boosting (XGBoost) model, the approaches described herein can dynamically optimize floor bid values at wire speed by analyzing historical auction bid data for training. With these techniques, floor bid values remain aligned with current demand, thereby improving the efficiency and outcomes of computer-managed real-time auctions.

Embodiments are adaptable to market changes, such as seasonal fluctuations and special events, ensuring they remain responsive to dynamic conditions. By periodically retraining a machine learning model based on new data and comparing historical and current data, a computer-implemented method can adjust floor bid values to reflect recent changes in bids. This dynamic adjustment mechanism maintains a balance between maximizing auction outcomes and keeping the bidding competitive and fair.

The approach also customizes floor bid values for different user groups based on various bid data parameters, ensuring more accurate and effective values. This tailored strategy, combined with the method's ability to make data-driven decisions and scale efficiently, provides a practical and robust solution for optimizing floor bid values. Thus, the techniques of the present disclosure provide a clear technical framework and practical application, presenting a concrete solution to real-world problems in the industry.

In the following description, for the purposes of explanation, numerous specific details are set forth to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

### 1. General Overview

Embodiments encompass the subject matter of the following numbered clauses:
1. A computer-implemented method comprising collecting bid data corresponding to bids of different user computers in a real-time computer-implemented auction, wherein each user computer is associated with a digital content item that a content server can serve to a web server; based on bid data parameters of the bid data, aggregating digital identifiers of user computers into a plurality of user groups, and digitally storing a training dataset comprising the bid data parameters and the user groups; training a machine learning model (MLM) using the training dataset to create and store a trained MLM; executing an inference stage of the trained MLM over input data comprising characteristics of a particular user group from among the plurality of user groups and revenue-per-thousand impressions data (RPM data) to output a prediction of a group-associated floor bid value for the particular user group; and transmitting, to the content server, the floor bid value and an identifier of the particular user group.
2. The computer-implemented method of clause 1, wherein the bid data parameters comprise bid date, bid hour, an operating system, a refresh number, a country code, a browser, an ad unit, and a user value group, wherein the user value group is a weighted daily average effective cost per thousand impressions (ECPM) associated with a particular digital content item.
3. The computer-implemented method of clause 2 further comprising computing the weighted daily average ECPM by weighting a daily average ECPM over a specified period.
4. The computer-implemented method of clause 3, wherein the specified period is between one month to six months.
5. The computer-implemented method of clause 3, wherein the specified period is 90 days.
6. The computer-implemented method of clause 3, further comprising computing the weighted daily average ECPM as

$${\sum }_{i = 1}^{n} ( {ECPM}_{i} \cdot {N}_{ADS i} \cdot {W}_{i} ) / ( {\sum }_{i = 1}^{n} {N}_{ADS i} \cdot {W}_{i} ) ,$$

wherein ECPMᵢ is an average daily bid, N_{ADS i} is a number of impressions shown for a given ad, Wᵢ is a weight based on how recent impressions for the given ad were shown, and n is a number of days over which the weighted daily average ECPM is computed.
7. The computer-implemented method of clause 6, further comprising rounding the weighted daily average ECPM to a nearest multiple of 0.05.
8. The computer-implemented method of clause 6, further comprising rounding the weighted daily average ECPM to a particular value from among a set of values comprising 0, 0.02, 0.05, 0.1, 0.15, 0.25, 0.35, 0.45, 0.55, 0.65, 0.75, 0.85, 0.95, 1.05, 1.15, 1.25, 1.35, 1.45, 1.55, 1.65, 1.75, 1.85, 1.95, 2.05, 2.15, 2.25, 2.35, 2.45, 2.55, 2.65, 2.75, 2.85, 2.95, 3.05, 3.15, 3.25, 3.35, 3.45, 3.55, 3.65, 3.75, 3.85, and 3.95.
9. The computer-implemented method of clause 8, wherein the RPM data includes average RPM determined one hour before determining the floor bid value and a 95th percentile RPM one hour before determining the floor bid value.
10. The computer-implemented method of clause 9, wherein the RPM data includes average RPM determined two hours before determining the floor bid value and a 95th percentile RPM two hours before determining the floor bid value.
11. The computer-implemented method of clause 10, wherein the RPM data includes average RPM determined three hours before determining the floor bid value and a 95th percentile RPM three hours before determining the floor bid value.
12. The computer-implemented method of clause 10, wherein the RPM data includes average RPM determined four hours before determining the floor bid value and a 95th percentile RPM four hours before determining the floor bid value.
13. The computer-implemented method of clause 12, further comprising updating the floor bid value after a specified period.
14. The computer-implemented method of clause 13, further comprising updating the floor bid value at least hourly, daily, or weekly.
15. The computer-implemented method of clause 13, further comprising determining a frequency of updating the floor bid value by an extent to which a maximum bid price for an auction exceeds a current floor bid value.
16. The computer-implemented method of clause 15, further comprising updating the floor bid value by computing the difference between the maximum bid price for an auction and the floor bid value, weighting the difference by a selected weight factor, and updating the floor bid value by the weighted difference.
17. The computer-implemented method of clause 13, further comprising determining a frequency of updating the floor bid value by an extent to which an average maximum bid price for a set of auctions exceeds a current floor bid value.
18. The computer-implemented method of clause 17, further comprising updating the floor bid value by computing a difference between the average maximum bid price and the floor bid value, weighting the difference by a selected weight factor, and updating the floor bid value by the weighted difference.
19. The computer-implemented method of clause 18, wherein the set of auctions comprises auctions performed within a previous hour.
20. The computer-implemented method of clause 1, wherein the MLM is an XGBoost model.
21. The computer-implemented method of clause 1, further comprising training the MLM by determining a target floor bid value based on historical floor bid values and historical auction bid data for a target user group from the plurality of user groups; forming a training dataset based on historical auction bid data; and building an optimized ensemble of decision trees based on the training dataset.
22. The computer-implemented method of clause 21, wherein the historical auction bid data comprises at least ECPM historical data.
23. The computer-implemented method of clause 21, further comprising using the historical auction bid data for forming a plurality of historical user groups.
24. The computer-implemented method of clause 21, further comprising determining the target floor bid value by: identifying a historical user group from the plurality of historical user groups as being the target user group; evaluating average daily ECPM for the identified historical user group; and computing the target floor bid value as the average daily ECPM divided by a thousand impressions.
25. The computer-implemented method of clause 24, further comprising determining that the computed target floor bid value is below a minimum threshold; and setting the target floor bid value to the threshold.
26. The computer-implemented method of clause 21 further comprising: obtaining a first data array of running hourly average RPM (HARPM) over a first period of time; obtaining a second data array of running hourly average RPM (HARPM) over a second period of time; determining that the average of the first data array differs from the average of the second data array by at least a minimum threshold; and retraining the MLM based on historical auction bid data and group-associated RPM-related data collected during the second period of time.
27. The computer-implemented method of clause 21, further comprising obtaining a demand predictor for a given ad, the demand predictor providing a likelihood of average RPM for an auction, and updating floor bid values based on the demand predictor.

### 2. Structural & Functional Overview

### 2.1 Distributed Computer System Example

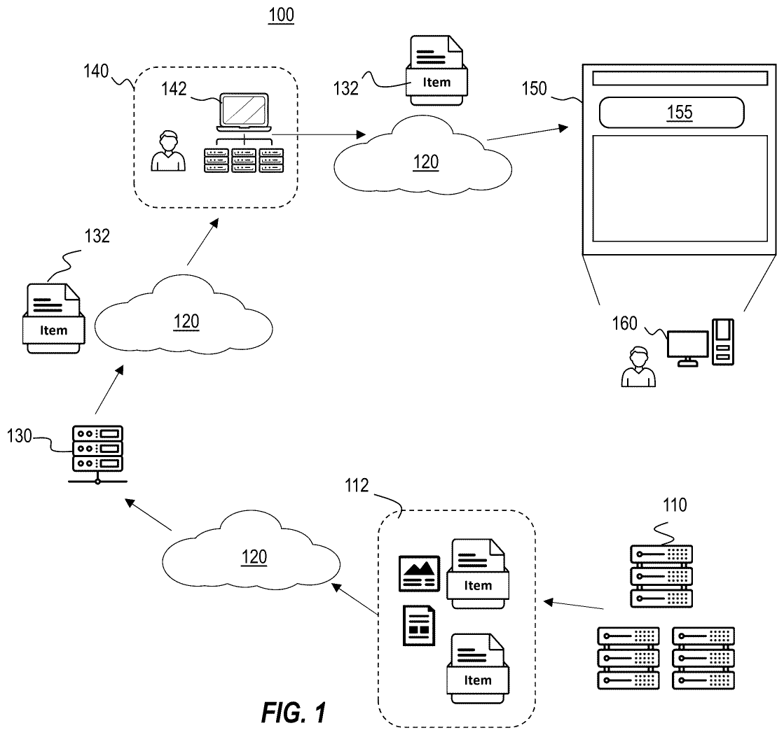

FIG. 1 illustrates a distributed computer system showing the context of use and principal functional elements with which one embodiment could be implemented. In an embodiment, a computer system 100 comprises components implemented partially by hardware at one or more computing devices, such as one or more hardware processors executing stored program instructions stored in memory for performing the functions described herein. In other words, all functions described herein are intended to indicate operations performed using programming in a special or general-purpose computer in various embodiments. FIG. 1 illustrates only one of many possible arrangements of components configured to execute the programming described herein. Other arrangements may include fewer or different components, and the division of work between the components may vary depending on the arrangement.

FIG. 1, and the other drawing figures and all of the description and claims in this disclosure, are intended to present, disclose, and claim a technical system and technical methods in which specially programmed computers, using a special-purpose distributed computer system design, execute functions that have not been available before to provide a practical application of computing technology to the problem of optimizing bidding for digital advertisement. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

FIG. 1 illustrates a distributed computer system for real-time bidding for the electronic delivery of digital content items, according to one embodiment. To illustrate a clear example, the description of FIG. 1 and other drawings figures refers, in some instances, to advertisers, digital ads, DSPs, SSPs, and other elements of digital advertising technology. However, embodiments are not limited to ad tech, and an embodiment can be implemented for use with content items that are not advertisements but other kinds of digital images, videos, animations, graphics, text, or electronic documents. The reader should not assume that the term “content item” is identical to “digital advertisement” unless the description states so expressly or the context requires.

A distributed computer system 100 involves several components and processes. Content source computers 110 comprise computers that supply the inventory of content items available for bidding. In an embodiment, content source computers 110 can be computers of businesses, advertising agencies, individuals, and non-profit organizations. Administrators or users of content source computers 110 can find webpages on which to bid primarily through demand-side platforms (DSPs), which connect them to ad exchanges and supply-side platforms (SSPs) where ad inventory is auctioned. Additionally, they may use ad networks that aggregate inventory from multiple publishers or negotiate direct deals for premium placements. Content source computers 110 can be part of a larger programmatic advertising ecosystem, which includes DSPs, SSPs, ad exchanges, ad networks, publishers, and data management platforms (DMPs). This ecosystem enables advertisers to bid on ad inventory in real-time auctions, ensuring efficient, data-driven, and targeted ad placements while allowing publishers to maximize their ad revenue.

FIG. 1 shows that content source computers 110 supply content items 112 for display on a computer-implemented platform of one or more publisher computers 140, which can be websites, social media services, apps, or other digital platforms that have spaces for displaying content items.

In various cases, a content server 130 plays a central role in managing the real-time bidding process for content source computers 110. When a user computer 160 visits a webpage 150 hosted by a publisher computer 140 operating a web server 142, a request for a content item is sent to content server 130. Content server 130 then initiates the bidding process by inviting bids from the pool of content items 112. Upon receiving the ad request, content server 130 broadcasts a bid request to potential content source computers 110, whose content items 112 are in the pool. Content source computers 110 respond by submitting their bid prices for the opportunity to display their content items. Content server 130 evaluates all received bids and selects content item 132 as having the highest bid.

Selecting content item 132 with the highest bid ensures that space for a content item is sold at the best possible price, maximizing revenue for the publisher. Web server 142 hosts webpage 150 where the content items will be displayed. After selecting content item 132, content server 130 sends this content item to web server 142. Web server 142 integrates the selected highest bid content item into the webpage content, for example, at a location 155 of the webpage 150. When user computer 160 accesses webpage 150, content item 132 is displayed.

In some cases, end-user such as user computer 160 interacts with webpage 150, where user computer 160 can view content item 132. User computer 160's interaction with content item 132 via clicks or impressions is tracked and reported back to content server 130 for performance analysis and future bid adjustments. In various embodiments, the transmission of data such as webpage data or advertisement data is performed via a network 120, which can be any suitable network. Network 120 can include the Internet, which facilitates global communication; local area networks (LANs), which connect devices within a limited area such as an office or building; and wide area networks (WANs), which cover larger geographic areas and connect multiple LANs. Additionally, wireless networks like Wi-Fi and cellular networks can transmit data between the system components, ensuring efficient and timely communication.

In various embodiments, each of the publisher computer 140, content server 130, web server 142, and content source computers 110 can be implemented using any of a server computer and/or one or more virtual compute instances and virtual storage instances executing in a private data center, public data center, or cloud computing center, under the control of stored program instructions that implement the functions described in other sections herein. The user computer 160 can be a laptop computer, desktop computer, or mobile computing device.

### 2.2 Example Data Processing Flows

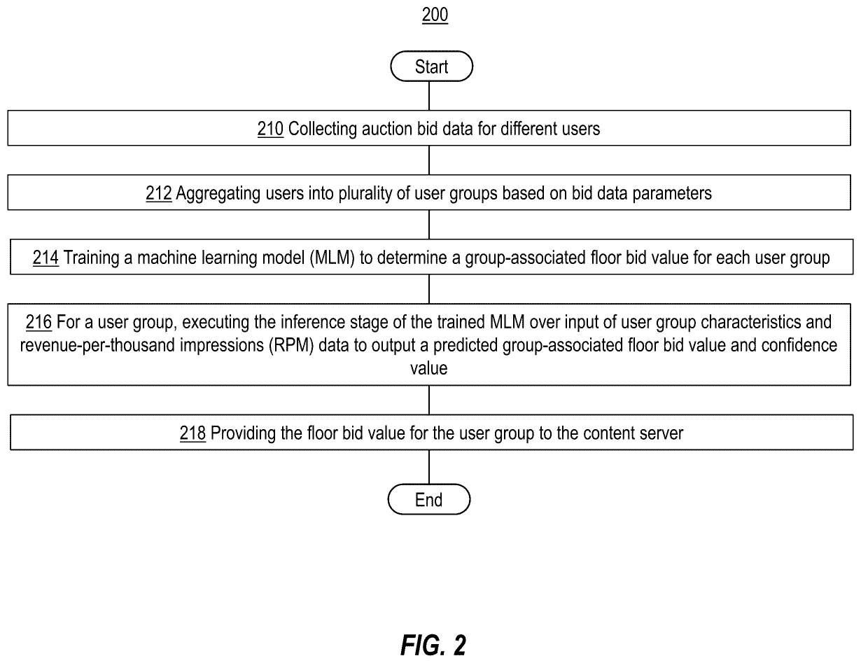

FIG. 2 is a method of determining a floor bid value using a machine learning model in one embodiment. FIG. 2 and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In one embodiment, publisher computer 140 is programmed to execute a computer-implemented method 200 via the programmatic steps shown in FIG. 2. In an embodiment, method 200 involves several steps, starting with data collection (step 210) and ending with providing the optimized floor bid values to the content item server (step 218). At step 210, method 200 includes collecting auction bid data for different users. This data includes information about bids placed by users in different auctions. It encompasses various parameters such as bid amounts, times of bids, user identifiers, and other relevant data points that can influence the bidding behavior.

At step 212, method 200 includes aggregating users into a plurality of user groups based on bid data parameters. The bid data parameters may include bid date, bid hour, an operating system, a refresh number, a country code, a browser, an ad unit, and a user value group, wherein the user value group is a weighted daily average effective cost per thousand impressions (ECPM) associated with a content item.

Such bid data parameters are important for aggregating users into relevant groups and for training the machine learning model to predict optimal floor bid values. These parameters are further outlined in detail below:

Bid date—the specific date on which the bid was placed. This parameter helps in identifying patterns and trends over time, such as daily or seasonal variations in bidding behavior.

Bid Hour—the specific hour of the day when the bid was placed. This parameter allows the analysis of hourly trends and the impact of different times of day on bidding activity and competition.

Operating system (OS)—the operating system used by the device from which the bid was placed, such as Windows, macOS, Linux, iOS, or Android. Different operating systems can have varying user behaviors and engagement levels, influencing bidding strategies. For example, operating systems used by large content providers often differ from those used by private owners due to each group's distinct needs and requirements. Large content providers typically operate in a professional and highly structured environment, which necessitates robust, secure, and scalable operating systems. They often use enterprise-grade operating systems like Windows Server, macOS for enterprise, or various distributions of Linux (such as Red Hat Enterprise Linux or Ubuntu Server) that offer advanced features for security, network management, and compatibility with enterprise software and hardware. On the other hand, private owners, such as individual content sources, advertisers, or small business owners, typically use consumer-grade operating systems like Windows 10 or 11, macOS, or popular Linux distributions such as Ubuntu or Fedora.

Refresh number—the number of times a slot for a content item has been refreshed and a new request for a content item has been made. This parameter helps in understanding user engagement and content fatigue, as well as optimizing the frequency of content item displays.

Country code—the user's geographic location, indicated by the country code. This is important for geo-targeting and understanding regional differences in bidding behavior and content item effectiveness. Other parameters like county and zip code can be used for associating a particular user with the geographic location.

Browser—the web browser used by the user, such as Chrome, Firefox, Safari, or Edge. Different browsers may have varying performance and compatibility with content items, affecting user interactions and bid values.

Content item unit—the specific content item placement or format, such as banner ads, video ads, or interstitial ads. Each content item unit can have different performance metrics and user engagement levels, impacting the bid amounts.

User value group—a classification based on the weighted daily average effective cost per thousand impressions (ECPM) associated with a content item. The user value group helps segment users according to their perceived value based on their historical engagement with content items. The ECPM can be calculated by first calculating the effective cost per thousand impressions (ECPM). This metric represents the average revenue generated per thousand content item impressions. It is calculated by dividing the total revenue generated by the total number of impressions and multiplying by 1000. Subsequently, a weighted daily average ECPM is calculated by taking a weighted average of the daily ECPMs, with more recent days and days with higher impressions given more weight. This helps in capturing the most relevant and current user behavior, providing a more accurate assessment of user value. The formula for calculating weighted ECPM (WECPM) is:

$$WECPM = {\sum }_{i = 1}^{n} ( {ECPM}_{i} \cdot {N}_{ADS i} \cdot {W}_{i} ) / ( {\sum }_{i = 1}^{n} {N}_{ADS i} \cdot {W}_{i} ) ,$$

wherein ECPMᵢ is the average daily bid, N_{ADS i} is the number of impressions shown for a given content item, Wᵢ is a weight based on how recent impressions for the given content item were shown, and n is the number of days over which the WECPM is computed. In some cases, the number of days can be a few days, a week, a few tens of days, a month, a few months, about 10 days, about 20 days, about 30 days, about 40 days, about 50 days, about 60 days, about 70, days, about 80 days, about 90 days, about 100 days, about 110, days, about 120 days, and the like. In some cases, the number of days may be about the same number of days that is used in a season (e.g., the number of days in a winter season, a summer season, a fall season, a spring season, a winter break, a spring break, a summer vacation, and the like). In various embodiments, WECPM is computed by weighted averaging daily average ECPM over any suitable predefined period, such as 90 days.

In the calculation for WECPM, weights Wᵢ can be selected in any suitable way. For instance, weights can be linearly or exponentially decreasing with time. For instance, Wᵢ can be given as Wᵢ=W₀exp(−τ·t), where t can denote time and τ is a coefficient controlling the reduction of weights with time. In some cases, different weights may be selected for different user groups, content items, and the like. In some cases, a linear or polynomial dependence of weight with time is possible, with suitable coefficients selected to describe the reduction of weight with time properly.

For example, if yesterday, 198 impressions were shown for a given content item at an average bid CPM of 3.25, and 41 days ago, for the same content item, 190 impressions were shown at an average bid CPM of 4.25, then the weighted ECPM calculation could be for the numerator

$${\sum }_{i = 1}^{n} ( {ECPM}_{i} \cdot {N}_{ADS i} \cdot {W}_{i} ) : ( 3.25 * 198 * 90 ) + ( 4.25 * 190 * 50 ) = 57885 + 40375 = 98260 ,$$

and for denominator

$$( {\sum }_{i = 1}^{n} {N}_{ADS i} \cdot {W}_{i} ) : ( 198 * 90 ) + ( 190 * 50 ) = 17820 + 9500 = 27320 ,$$

thus WECPM=98260/27320, which is about 3.6.

In various cases, the WECPM can be rounded for convenience. For example, WECPM may be rounded to the nearest multiple of 0.05 or can be rounded to a set of values such as 0, 0.02, 0.05, 0.1, 0.15, 0.25, 0.35, 0.45, 0.55, 0.65, 0.75, 0.85, 0.95, 1.05, 1.15, 1.25, 1.35, 1.45, 1.55, 1.65, 1.75, 1.85, 1.95, 2.05, 2.15, 2.25, 2.35, 2.45, 2.55, 2.65, 2.75, 2.85, 2.95, 3.05, 3.15, 3.25, 3.35, 3.45, 3.55, 3.65, 3.75, 3.85, 3.95.

By aggregating users based on these detailed bid data parameters, the system can more accurately analyze and predict user behavior, optimize floor bid prices, and ultimately enhance the efficiency and profitability of digital content item campaigns.

After aggregating users into a plurality of user groups, method 200 includes, at step 214, training a Machine Learning Model (MLM) to determine a group-associated floor bid value for each user group in the plurality of user groups. The training involves feeding the MLM with historical bid data and other relevant features to learn patterns and make accurate predictions. When executing the inference stage over a set of input values, the resulting MLM is trained to output an optimized floor bid value. Optimization can have any of several technical or business goals, including but not limited to maximizing revenue, ensuring competitive bidding, and increasing content item quality.

At step 216, method 200 comprises, for a user group, executing the inference stage of the trained MLM over an input of user group characteristics and revenue-per-thousand impressions (RPM) data to output a predicted group-associated floor bid value and confidence value. Thus, for each user group, the trained MLM generates output based in part on user group characteristics and revenue-per-thousand impressions (RPM) data. This step ensures that the floor bid value is set at an optimal level, balancing the need to maximize the bid price while maintaining a high fill rate for content item impressions, thereby maximizing the revenue. The MLM output may include a confidence value associated with its prediction of a group-associated floor bid value or a plurality of predicted group-associated floor bid values and corresponding confidence values. Step 216 can be programmed to include discarding predicted values that are associated with confidence values below a configured, specified, predetermined, or programmed minimum confidence value.

At step 218, method 200 includes providing the content item server with the floor bid value for the user group from the plurality of user groups. The content item server uses these floor bid values in real-time bidding auctions to ensure that the minimum acceptable bid meets the revenue targets and strategic goals set by the publishers.

In various cases, the RPM data used for determining the floor bid value can include the average RPM determined one hour before determining the floor bid value and the 95th percentile RPM one hour before determining the floor bid value. In some cases, the RPM data may include the average RPM determined two hours before determining the floor bid value and the 95th percentile RPM two hours before determining the floor bid value. Further, in some cases, the RPM data may include the average RPM determined three hours before determining the floor bid value and the 95th percentile RPM three hours before determining the floor bid value. Additionally, in some cases, the RPM data may include the average RPM determined four hours before determining the floor bid value and the 95th percentile RPM four hours before determining the floor bid value.

In some cases, the floor bid value can be updated at least hourly, daily, or weekly. This means that the system periodically recalculates the minimum acceptable bid price for content items based on the latest available data. By updating the floor bid value at these regular intervals, the system ensures that the floor bids remain aligned with current market conditions. Hourly updates allow for rapid adjustments in response to short-term fluctuations, daily updates provide a balanced approach to capturing daily trends, and weekly updates accommodate broader, more stable market movements.

The frequency of updating the floor bid value may be determined by the extent to which a maximum bid price for an auction exceeds the current floor bid value. In this embodiment, the system dynamically adjusts the frequency of floor bid value updates based on the bidding behavior observed in auctions. When the maximum bid price significantly exceeds the current floor bid value, it indicates a strong demand for the content item inventory. As a result, the system increases the frequency of updates to capitalize on this demand and adjusts the floor price more frequently, ensuring that the content item inventory is not undervalued and revenue is maximized.

In some cases, the floor bid value is updated by computing the difference between the maximum bid price for an auction and the floor bid value, weighting the difference by a selected weight factor, and updating the floor bid value by the weighted difference. The method can assess the potential value gap by determining the difference between the highest bid and the current floor bid value. Applying a weight factor to this difference allows for controlled adjustments, preventing abrupt changes and ensuring stability. The floor bid value is then updated by adding the weighted difference, thus incrementally aligning the floor price with market demand without causing significant disruptions.

In some cases, the frequency of updating the floor bid value is determined by the extent to which an average maximum bid price for a set of auctions exceeds the current floor bid value. This method takes into account the average maximum bid prices across multiple auctions rather than relying on individual auction results. By averaging the maximum bids, the system can smooth out anomalies and better understand overall market trends. If the average maximum bid value substantially exceeds the current floor bid value, the system increases the update frequency to adjust the floor bid value more rapidly, ensuring it reflects the collective demand indicated by the series of auctions.

In some cases, the floor bid value is updated by computing the difference between the average maximum bid price and the floor bid value, weighting the difference by a selected weight factor, and updating the floor bid value by the weighted difference. Such an approach involves calculating the difference between the average maximum bid price and the current floor bid value. The difference is then weighted by a chosen factor to moderate the adjustment, ensuring that changes to the floor bid value are proportionate and do not introduce volatility. By updating the floor bid value with this weighted difference, the method maintains a balance between responsiveness to market conditions and stability of the bidding environment.

In various embodiments, the set of auctions includes auctions performed within a configured, specified, or predetermined period of time, such as within a previous hour, two hours, three hours, four hours, and the like. This ensures that the data used for updating the floor bid value is relatively recent and reflects the current market conditions. By focusing on hourly auction data, the system can make timely adjustments to the floor bid value, enhancing its ability to respond swiftly to changes in demand and optimizing revenue opportunities. This granularity in the time frame helps maintain the relevance and accuracy of the floor bid value adjustments. Time period values can be stored in configuration data in storage of the content server 130.

In various embodiments, the MLM for determining group-associated floor bid value for each user group may be an XGBoost model. Using XGBoost for floor bid value prediction in digital advertising involves a comprehensive process of data preparation, feature engineering, model training, and deployment. Initially, vast amounts of auction bid data are collected and preprocessed, with key features extracted, including bid date, bid hour, operating system, refresh number, country code, browser, ad unit, and user value group. Feature engineering enhances predictive power by creating lagged features, aggregated features like rolling averages and percentiles, and interaction features. The XGBoost model is then trained by optimizing an objective function, such as mean squared error, within a gradient boosting framework where each tree corrects errors from previous iterations. Decision trees are constructed using a greedy algorithm with parameters like max depth, min child weight, and gamma to control complexity and prevent overfitting. Regularization techniques (L1 and L2) ensure robustness, while a learning rate and shrinkage prevent overfitting and enhance generalization. Early stopping is used to halt training when validation performance ceases to improve. Model performance is evaluated using metrics like RMSE, MAE, and R-squared, and cross-validation ensures robustness. Hyperparameter tuning via grid search, random search, or Bayesian optimization identifies the optimal settings for parameters like the number of trees, max depth, learning rate, min child weight, subsample, and colsample_bytree.

Once trained and tuned, the model is deployed to predict floor bid values in real time, using relevant features for each user group to generate optimal values. When an MLM is trained and deployed in the manner described herein, the MLM can be called programmatically to execute the inference stage over input data comprising characteristics of a particular user group from among the plurality of user groups and revenue-per-thousand impressions data (RPM data) to output a prediction of a group-associated floor bid value for the particular user group; and to transmit, to the content server, the floor bid value and an identifier of the particular user group. These operations execute in CPU cycles using from dozens to the low hundreds of milliseconds, enabling real-time, wire speed responses to bids in online auctions where the delivery of content items to the web server rapidly is a requirement.

In various embodiments, publisher computer 140 communicates floor bid values to content server 130 using a suitable API. Content server 130 typically hosts an API endpoint that publisher computer 140 can call. Data is transmitted via HTTP POST requests containing floor bid prices in a predefined JSON or XML format, with necessary data parsing and authentication headers. Upon receiving the request, content server 130 processes the data and responds with an acknowledgment, confirming the successful communication of floor bid prices. Ongoing communication includes regularly sending updated floor bid prices to content server 130 by publisher computer 140 at predetermined intervals or in response to market condition changes, ensuring that content server 130 always has the latest prices for auctions.

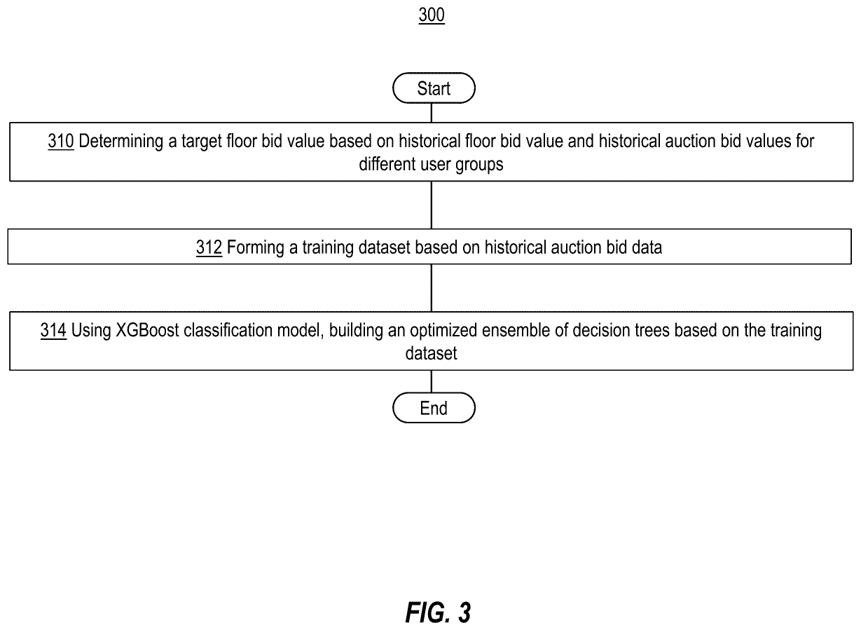

FIG. 3 illustrates a computer-implemented method of training a machine learning model for determining a floor bid value in one embodiment. In one embodiment, publisher computer 140 executes a method 300 for using an XGBoost classification model to predict floor bid values in digital advertising.

Method 300 includes, at step 310, determining a target floor bid value based on historical floor bid values and historical auction bid prices for different user groups. The target floor bid value is calculated based on historical data, including past floor bid values and auction bid values or prices. In one embodiment, the historical auction bid data includes at least ECPM (Effective Cost Per Thousand Impressions) historical data. This data can be utilized to form a plurality of historical user groups. For instance, such data can be employed to aggregate users into groups.

In one embodiment, the target floor bid value for a particular user group is determined by first identifying a historical user group from the plurality of historical user groups that match the target user group. The average daily ECPM for the identified historical user group is then evaluated, and the target floor bid value is computed as the average daily ECPM divided by one thousand impressions.

In some cases, when the target floor bid value is below a minimum threshold, method 300 optionally includes setting the target floor bid value to the threshold. The threshold can be any suitable number. In some cases, such a threshold can be obtained by evaluating historical data. For example, the system could analyze the average floor bid values over the past six months and set the threshold to the 10th percentile (or any other suitable percentile) of these historical prices, ensuring that the floor bid value is always within a competitive range. Different thresholds can sometimes be set for different geographic regions based on the local market conditions. For instance, the threshold for the US market could be higher than for other regions due to higher average CPMs in the US. Further, the threshold can be adjusted based on seasonal trends in some cases. For example, during peak advertising seasons such as holidays or major events, the threshold could be increased to capitalize on higher demand, while it could be lowered during off-peak periods. It should be noted that any combination of considerations and/or other suitable considerations can be used to determine the threshold.

After completion of step 310, method 300 proceeds to step 312 of forming a training dataset based on historical auction bid data. The training dataset is composed of historical auction bid data, including all relevant features such as bid amounts, bid times, user characteristics, and, in some cases, contextual information. In some cases, the training data can be represented by Table 1, as shown below.

TABLE 1
Training dataset data example.

| | | | | | | Floor bid |
|---|---|---|---|---|---|---|
| Group | ARPM1 | 95RPM1 | . . . | ARPM4 | 95RPM4 | value |
| 1: (US, Safari, user group | 0.1 | 0.2 | . . . | 0.3 | 0.4 | 0.25 |
| value = .1, os = MacOS, | | | | | | |
| date, hour, ad unit) | | | | | | |
| 2: (US, Chrome, user | .1 | .25 | | .35 | .45 | .3 |
| value = .1, os = Win, ref = 1, | | | | | | |
| date, hour, ad unit) | | | | | | |
| 3: (US, Chrome, user | 0.3 | 0.35 | | 0.4 | 0.45 | 0.5 |
| value = .2, os = Linux, ref = 1, | | | | | | |
| date, hour, ad unit) | | | | | | |

In Table 1 above, ARPM1 represents the average RPM obtained one hour prior to collecting information about the floor bid value, while ARPM4 represents the average RPM obtained four hours prior to collecting information about the floor bid value. Similarly, 95RPM1 is the 95th percentile RPM one hour before collecting the floor bid value, and 95RPM4 is the 95th percentile RPM four hours before collecting the floor bid value. The “ . . . ” in Table 1 indicates additional RPM values (similar to ARPM1 and 95RPM1) collected two and three hours prior to collecting information about the floor bid value.

The Group column (first column in Table 1) is characterized by various bid data parameters such as country (e.g., US), browser (e.g., Safari or Chrome), user group value (e.g., 0.1 or 0.2), operating system (e.g., OS=MacOS, Windows, or Linux), refresh number, date, hour, and ad unit. These parameters help define distinct user groups for determining the floor bid values.

For example, Group 1 is defined by users in the US using the Safari browser, with a user group value of 0.1, an operating system identifier of MacOS, and includes specific date, hour, and ad unit details. The average RPM and 95th percentile RPM values for one and four hours prior are provided, along with the computed floor bid value of 0.25.

After completion of step 312, method 300 proceeds to step 314. At step 314, the XGBoost classification model is used to build an optimized ensemble of decision trees. The training dataset is fed into the XGBoost algorithm, which constructs multiple decision trees in a sequential manner. Each tree in the ensemble corrects the errors of the previous trees, enhancing the model's accuracy and predictive power. The XGBoost model utilizes techniques such as gradient boosting, regularization, and hyperparameter tuning to optimize the decision trees and prevent overfitting.

In some cases, the MLM for predicting floor bid values can be retrained based on changing demand patterns associated with various market changes, such as seasonal fluctuations or specific events (e.g., construction, holidays, etc.). For instance, in one embodiment, the retraining process involves first obtaining two distinct data arrays. The first data array consists of running hourly average RPM (HARPM) values over a designated initial period of time. Similarly, the second data array is composed of running hourly average RPM (HARPM) values over a subsequent period of time. The system then compares the average values of these two data arrays. If the difference between the averages of the first and second data arrays meets or exceeds a predetermined minimum threshold, this triggers a retraining of the machine learning model (MLM). The retraining process can use historical auction bid data along with group-associated RPM-related data that was collected during the second period of time. This ensures that the MLM is updated to reflect recent changes in bidding behavior and market conditions, thereby improving its predictive accuracy. In an example embodiment, the period of time can be an hour, a few hours, a day, a week, a month, a few months, and the like.

When retraining the MLM, a demand predictor specific to a given advertisement may be obtained in some cases. This demand predictor can provide an estimate of the likelihood of achieving a certain average RPM for an auction involving the ad. By leveraging the demand predictor, the system can anticipate the potential revenue performance of the ad under different auction scenarios. This predictive capability allows for more informed decision-making and optimization of bidding strategies, ensuring that the floor bid values set by the MLM are aligned with market demand and revenue goals.

### 3. Implementation Example-Hardware Overview

According to one embodiment, the techniques described herein are implemented by at least one computing device. The techniques may be implemented in whole or in part using a combination of at least one server computer and/or other computing devices coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. To accomplish the described techniques, such computing devices may combine custom hard-wired logic, ASICs, or FPGAs with custom programming. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

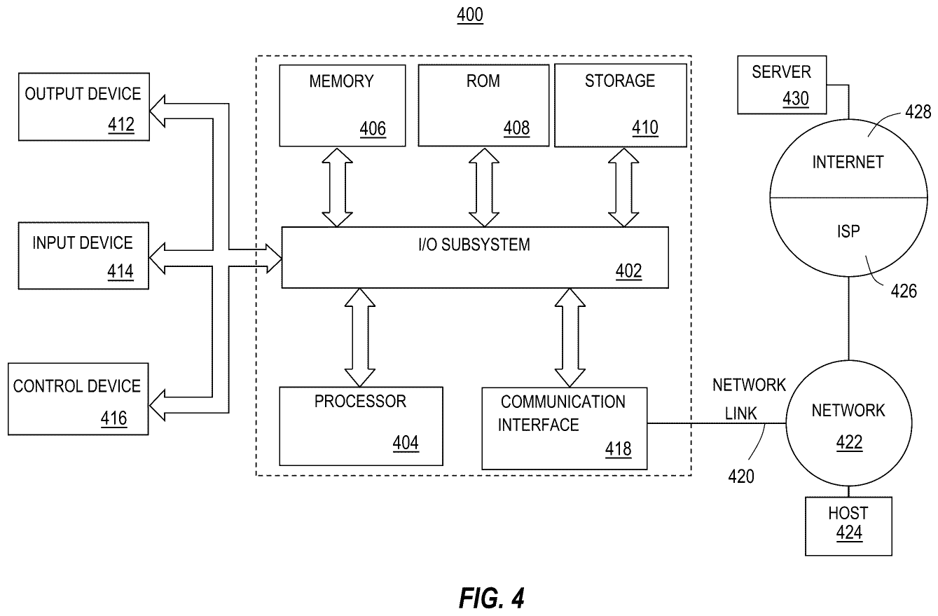

FIG. 4 is a block diagram that illustrates an example computer system with which an embodiment may be implemented. In the example of FIG. 4, a computer system 400 and instructions for implementing the disclosed technologies in hardware, software, or a combination of hardware and software are represented schematically, for example, as boxes and circles, at the same level of detail that is commonly used by persons of ordinary skill in the art to which this disclosure pertains for communicating about computer architecture and computer systems implementations.

Computer system 400 includes an input/output (I/O) subsystem 402, which may include a bus and/or other communication mechanism(s) for communicating information and/or instructions between the components of the computer system 400 over electronic signal paths. The I/O subsystem 402 may include an I/O controller, a memory controller, and at least one I/O port. The electronic signal paths are represented schematically in the drawings, such as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system, a graphics processing unit (GPU), a digital signal processor, or an ARM processor. Processor 404 may comprise an integrated arithmetic logic unit (ALU) or be coupled to a separate ALU.

Computer system 400 includes one or more units of memory 406, such as a main memory, coupled to I/O subsystem 402 for electronically digitally storing data and instructions to be executed by processor 404. Memory 406 may include volatile memory such as various forms of random-access memory (RAM) or other dynamic storage device. Memory 406 may also be used for storing temporary variables or other intermediate information during the execution of instructions to be executed by processor 404. Such instructions, when stored in non-transitory computer-readable storage media accessible to processor 404, can render computer system 400 into a special-purpose machine customized to perform the operations specified in the instructions.

Computer system 400 includes non-volatile memory such as read-only memory (ROM) 408 or other static storage devices coupled to I/O subsystem 402 for storing information and instructions for processor 404. The ROM 408 may include various forms of programmable ROM (PROM), such as erasable PROM (EPROM) or electrically erasable PROM (EEPROM). A unit of persistent storage 410 may include various forms of non-volatile RAM (NVRAM), such as FLASH memory, solid-state storage, magnetic disk, or optical disks such as CD-ROM or DVD-ROM and may be coupled to I/O subsystem 402 for storing information and instructions. Storage 410 is an example of a non-transitory computer-readable medium that may be used to store instructions and data which, when executed by the processor 404, cause performing computer-implemented methods to execute the techniques herein.

The instructions in memory 406, ROM 408, or storage 410 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation, application, and data storage layer, such as a relational database system using a structured query language (SQL) or no SQL, an object store, a graph database, a flat file system, or other data storage.

Computer system 400 may be coupled via I/O subsystem 402 to at least one output device 412. In one embodiment, output device 412 is a digital computer display. Examples of a display that may be used in various embodiments include a touchscreen display, a light-emitting diode (LED) display, a liquid crystal display (LCD), or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections, or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. The control device 416 may be a touchpad, a mouse, a trackball, or cursor direction keys for communicating direction information and command selections to processor 404 and for controlling cursor movement on an output device 412, such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other control device. An input device 414 may include a combination of multiple input devices, such as a video camera and a depth sensor.

In another embodiment, computer system 400 may comprise an Internet of Things (IoT) device in which one or more of the output devices 412, input device 414, and control device 416 are omitted. Or, in such an embodiment, the input device 414 may comprise one or more cameras, motion detectors, thermometers, microphones, seismic detectors, other sensors or detectors, measurement devices or encoders, and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware, and interfaces for generating position reporting packets, notifications, pulse or heartbeat signals, or other recurring data transmissions that specify a position of the computer system 400, alone or in combination with other application-specific data, directed toward host computer 424 or server computer 430.

Computer system 400 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct but may be used with transmission media. Transmission media participates in transferring information between storage media. For example, transmission media includes coaxial cables, copper wire and fiber optics, and wires comprising a bus of I/O subsystem 402. Transmission media can also be acoustic or light waves generated during radio-wave and infrared data communications.

Various forms of media may carry at least one sequence of at least one instruction to processor 404 for execution. For example, the instructions may initially be carried on a remote computer's magnetic disk or solid-state drive. The remote computer can load the instructions into its dynamic memory and send them over a communication link such as a fiber optic, coaxial cable, or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal. Appropriate circuitry can provide the data to I/O subsystem 402, such as placing the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to a bus or I/O subsystem 402. Communication interface 418 provides a two-way data communication coupling to a network link(s) 420 directly or indirectly connected to at least one communication network, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 422 broadly represents a local area network (LAN), wide-area network (WAN), campus network, internetwork, or any combination thereof. Communication interface 418 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic, or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may connect through network 422 to a host computer 424.

Furthermore, network link 420 may connect through network 422 or to other computing devices via internetworking devices and/or computers operated by an Internet Service Provider (ISP) 426. ISP 426 provides data communication services through a worldwide packet data communication network called Internet 428. A server computer 430 may be coupled to Internet 428. Server computer 430 broadly represents any computer, data center, virtual machine, or virtual computing instance with or without a hypervisor or computer executing a containerized program system such as DOCKER or KUBERNETES. Server computer 430 may represent an electronic digital service that is implemented using more than one computer or instance, and that is accessed and used by transmitting web services requests, uniform resource locator (URL) strings with parameters in HTTP payloads, API calls, app services calls, or other service calls. Computer system 400 and server computer 430 may form elements of a distributed computing system that includes other computers, a processing cluster, a server farm, or other organizations of computers that cooperate to perform tasks or execute applications or services. Server computer 430 may comprise one or more instructions organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 430 may comprise a web application server that hosts a presentation layer, application layer, and data storage layer, such as a relational database system using a structured query language (SQL) or no SQL, an object store, a graph database, a flat file system or other data storage.

Computer system 400 can send messages and receive data and instructions, including program code, through the network(s), network link 420, and communication interface 418. In the Internet example, server computer 430 might transmit a requested code for an application program through Internet 428, ISP 426, local network 422, and communication interface 418. The received code may be executed by processor 404 as it is received and/or stored in storage 410 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. Accordingly, the specification and drawings are to be regarded in an illustrative rather than a restrictive sense. The sole and exclusive indicator of the scope of the invention, and what is intended by the applicants to be the scope of the invention, is the literal and equivalent scope of the set of claims that are issued from this application in the specific form in which such claims issue, including any subsequent correction.

What is claimed is:

1. A computer system comprising:
one or more processors; and
one or more non-transitory computer-readable storage media storing one or more sequences of instructions which, when executed by the one or more processors, cause the one or more processors to execute:
collecting, by a plurality of content source computers, bid data corresponding to bids of different user computers in a real-time computer-implemented auction, wherein each user computer is associated with a digital content item that a content server can serve to a web server;
based on bid data parameters of the bid data, aggregating digital identifiers of user computers into a plurality of user groups, and digitally storing a training dataset comprising the bid data parameters and the user groups;
training a machine learning model (MLM) using the training dataset to create and store a trained MLM;
executing an inference stage of the trained MLM over input data comprising characteristics of a particular user group from among the plurality of user groups and revenue-per-thousand impressions data (RPM data) to output a prediction of an associated floor bid value for the particular user group;
transmitting, to the content server, the floor bid value and an identifier of the particular user group; and
dynamically adjusting, by the content server, a frequency of updating the floor bid value, wherein the adjusting occurs when an average maximum bid price for a set of auctions exceeds the floor bid value.

2. The computer system of claim 1, wherein the bid data parameters comprise bid date, bid hour, an operating system, a refresh number, a country code, a browser, an ad unit, and a user value group, wherein the user value group is a weighted daily average effective cost per thousand impressions (ECPM) associated with a particular digital content item.

3. The computer system of claim 2 further comprising computing the weighted daily average ECPM by weighting a daily average ECPM over a specified period.

4. The computer system of claim 3, wherein the specified period is between one month to six months.

5. The computer system of claim 3, wherein the specified period is 90 days.

6. The computer system of claim 3, further comprising computing the weighted daily average ECPM as
$${\sum }_{i = 1}^{n} ( {ECPM}_{i} \cdot {N}_{ADS i} \cdot {W}_{i} ) / ( {\sum }_{i = 1}^{n} {N}_{ADS i} \cdot {W}_{i} ) ,$$
wherein ECPMᵢ is an average daily bid, N_{ADS i} is a number of impressions shown for a given ad, Wᵢ is a weight based on how recent impressions for the given ad were shown, and n is a number of days over which the weighted daily average ECPM is computed.

7. The computer system of claim 6, further comprising rounding the weighted daily average ECPM to a nearest multiple of 0.05.

8. The computer system of claim 6, further comprising rounding the weighted daily average ECPM to a particular value from among a set of values comprising 0, 0.02, 0.05, 0.1, 0.15, 0.25, 0.35, 0.45, 0.55, 0.65, 0.75, 0.85, 0.95, 1.05, 1.15, 1.25, 1.35, 1.45, 1.55, 1.65, 1.75, 1.85, 1.95, 2.05, 2.15, 2.25, 2.35, 2.45, 2.55, 2.65, 2.75, 2.85, 2.95, 3.05, 3.15, 3.25, 3.35, 3.45, 3.55, 3.65, 3.75, 3.85, and 3.95.

9. The computer system of claim 8, wherein the RPM data includes average RPM determined one hour before determining the floor bid value and a 95th percentile RPM one hour before determining the floor bid value.

10. The computer system of claim 9, wherein the RPM data includes average RPM determined two hours before determining the floor bid value and a 95th percentile RPM two hours before determining the floor bid value.

11. The computer system of claim 10, wherein the RPM data includes average RPM determined three hours before determining the floor bid value and a 95th percentile RPM three hours before determining the floor bid value.

12. The computer system of claim 10, wherein the RPM data includes average RPM determined four hours before determining the floor bid value and a 95th percentile RPM four hours before determining the floor bid value.

13. The computer system of claim 12, further comprising updating the floor bid value after a specified period.

14. The computer system of claim 13, further comprising updating the floor bid value at least hourly, daily, or weekly.

15. The computer system of claim 1, further comprising updating the floor bid value by computing the difference between the maximum bid price for an auction and the floor bid value, weighting the difference by a selected weight factor, and updating the floor bid value by the weighted difference.

16. The computer system of claim 1, further comprising updating the floor bid value by computing a difference between the average maximum bid price and the floor bid value, weighting the difference by a selected weight factor, and updating the floor bid value by the weighted difference.

17. The computer system of claim 16, wherein the set of auctions comprises auctions performed within a previous hour.

18. The computer system of claim 1, wherein the MLM is an XGBoost model.

19. The computer system of claim 1, further comprising training the MLM by determining a target floor bid value based on historical floor bid values and historical auction bid data for a target user group from the plurality of user groups; forming a training dataset based on historical auction bid data; and building an optimized ensemble of decision trees based on the training dataset.

20. The computer system of claim 19, wherein the historical auction bid data comprises at least ECPM historical data.

21. The computer system of claim 19, further comprising using the historical auction bid data for forming a plurality of historical user groups.

22. The computer system of claim 19, further comprising determining the target floor bid value by:
identifying a historical user group from the plurality of historical user groups as being the target user group;
evaluating average daily ECPM for the identified historical user group; and
computing the target floor bid value as the average daily ECPM divided by a thousand impressions.

23. The computer system of claim 22, further comprising determining that the computed target floor bid value is below a minimum threshold; and setting the target floor bid value to the threshold.

24. The computer system of claim 19 further comprising:
obtaining a first data array of running hourly average RPM (HARPM) over a first period of time;
obtaining a second data array of running hourly average RPM (HARPM) over a second period of time;
determining that the average of the first data array differs from the average of the second data array by at least a minimum threshold; and
retraining the MLM based on historical auction bid data and group-associated RPM-related data collected during the second period of time.

25. The computer system of claim 22, further comprising obtaining a demand predictor for a given ad, the demand predictor providing a likelihood of average RPM for an auction, and updating floor bid values based on the demand predictor.
